(19) United States
(12) Patent Application Publication
(10) Pub. No.: US 2011/0184940 A1
(43) Pub. Date: Jul. 28, 2011

(54) SYSTEM AND METHOD FOR DETECTING CHANGES IN THE RELEVANCE OF PAST SEARCH RESULTS

(75) Inventor: Muhammed Abdul Fazil, Calicut (IN)

(73) Assignee: Yahoo! Inc., Sunnyvale, CA (US)

(21) Appl. No.: 12/693,987

(22) Filed: Jan. 26, 2010

(51) Int. Cl. G06F 17/30

(52) U.S. Cl. 707/723; 707/E17.084

(57) ABSTRACT

A query is received for a web search from a user, via a network. A search is performed for a first plurality of objects which match the query, whereby a first search result is produced. The first search result is ranked producing a first ranked search result. The occurrence of a trigger event is detected. A search is performed for a second plurality of objects accessible over the network which match the query, whereby a second search result is produced. The second search result is ranked producing a second ranked search result. The first ranked search result is compared with the second ranked search result wherein a delta score is determined for each reference in the second ranked search result. At least one of the references in the second ranked result set having a positive delta score is selected using and transmitted, over the network, to the user.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to systems and methods for improving the relevance of the results returned by web searches and, more particularly, to systems and methods improving the relevance of the results returned by web searches by detecting changes in the relevance of past search results.

### BACKGROUND OF THE INVENTION

When a user submits a query to a search engine, the search engine commonly returns a large search result containing hundreds or thousands of links which may be of potential relevance to the user. Typically, the user reviews the first few pages of such search results, but rarely more than that. The user may finds is a couple of links relevant to the query, but the results may not be exactly what the user was looking for. It may be the case, however, that links of great interest to the user that appear on later pages of the search result that the user never reviews.

Nevertheless, it is possible that the user will remain interested in the information he or she was seeking over a period of time. It also possible that links of interest which the search engine did not place on the first page of search results at an earlier date may later increase in relevance for a variety of reasons.

### SUMMARY OF THE INVENTION

In one embodiment, the invention is a method. A query is received for a web search from a user, via a network. A search is performed, using at least one computing device, for a first plurality of objects accessible over the network which match the query, whereby a first search result is produced, the first search result comprising a plurality of references, each reference referring to one of the first plurality of objects. The first search result is ranked, using the computing device, using a first ranking methodology, producing a first ranked search result.

The occurrence of a trigger event is detected, using the computing device. A search is performed, using the computing device, for a second plurality of objects accessible over the network which match the query, whereby a second search result is produced, the second search result comprising a plurality of references, each reference referring to one of the second plurality of objects. The second search result is ranked, using the computing device, using a second ranking methodology, producing a second ranked search result. The occurrence of a trigger event is detected, using the computing device.

The first ranked search result is compared with the second ranked search result, using the computing device, wherein a delta score is determined for each reference in the second ranked search result. At least one of the references in the second ranked result set having a positive delta score is selected using the computing device. The selected references are then transmitted, over the network, to the user.

In one embodiment, the invention is a system. The system comprises a number of modules, each module comprising one or more processors programmed to execute software code retrieved from a computer readable storage medium storing software for performing various functions. Such modules include: a query receiving module for receiving queries for web searches from users, via a network; a web search module for searching, using queries, for pluralities of objects accessible over the network which match the respective queries, each plurality of objects comprising a search result for a query processed by the web search module; a search result ranking module for ranking each of the search results using a ranking methodology, producing ranked search results; an event detection module for detecting the occurrence of a trigger events related to queries processed by the web search modules; a search result comparison module for comparing a first ranked search result produced by the search result ranking module with a second ranked search result produced by the search result ranking module, wherein a delta score is determined for each reference in the second ranked search results, wherein, for each such comparison, at least one of the references in the second ranked result set having a positive delta score is selected; and a search result transmission module for transmitting, over the network, for each comparison, the at least one of the selected references in the second ranked result set to a user that originally entered the query.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 illustrates one embodiment of a user interface for displaying changes in search result relevance.

FIG. 2 illustrates one embodiment of a user interface for displaying changes in search result relevance.

FIG. 3 illustrates one embodiment of a user interface for displaying changes in search result relevance.

FIG. 4 illustrates one embodiment of a user interface for displaying changes in search result relevance.

FIG. 5 illustrates one embodiment of a system capable of supporting at least one embodiment of the systems and methods described herein.

FIG. 6 illustrates one embodiment of a process for providing search services which include detection of changes in search result relevance.

FIG. 7 illustrates one embodiment of a web search services engine and a search result relevance tracking engine, that, in conjunction, are capable of supporting at least one embodiment of the process described in FIG. 6.

### DETAILED DESCRIPTION

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure the term “end user” or “user” should be understood to refer to a consumer of data supplied by a data provider. By way of example, and not limitation, the term “end user” can refer to a person who receives data provided by the data provider over the Internet in a browser session, or can refer to an automated software application which receives the data and stores or processes the data.

For the purposes of this disclosure, a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which can be used to store the desired information and which can be accessed by the computer.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may grouped into an engine or an application.

The present invention is directed to systems and methods for improving the relevance of the results returned by web searches by detecting changes in the relevance of past search results. In one embodiment, search results received by users in response to search queries are tracked over time such that if the relevance of one or more of such search results for a given query changes, the user issuing the query is notified.

A typical web query search result can contain hundreds or thousands of links. Generally, however, users are not inclined, and may not even have the time, to view more than a few pages of such results. The user depends on search engine to rank search results such that the results of greatest relevance to the user appear on the first few pages of the search results.

The relevance of a given link to a specific query or a specific user may, however, change over time. One reason this may be the case is that the content of the link changes to include more information that is relevant to the query. For example, if a query is treated as a bag of words and ranked accordingly, the document may change to include more references to the query terms. Another reason why the relevance given link to a query may change is that the search engine's ranking algorithm may be changed or improved periodically. Where search result ranking is enhanced using user profile data or data from a user's social network, the user's profile or social network may change.

Thus, for example, a link in a search result might, one week, be ranked such that it falls on the tenth page of a search result, but a month later, may be ranked such that it falls on the first or second page of a search result. Unless the user periodically resubmits the query to the search engine, the user may never become aware of the change. Moreover, the fact that a link in a search result has changed in relevance may be of interest in and of itself, indicating, for example, a link showing recent updates relevant to the query.

One method of detecting changes in the relevance of links within a search result is to store at least a portion of the search results as of a given date in association with the user and the query that produced the search results. The queries could then be periodically resubmitted to the search engine and the new search results could be compared to the previous search results for the query and a delta score could be determined for links whose ranking has changed significantly. Such a delta score could simply be a link's current rank subtracted from the link's previous rank, for example, a link previously ranked at 190 and currently ranked at 30 would have a delta score of +160 using such a technique.

Alternatively or additionally, other mathematical techniques could be used to compute or scale the delta factor. For example, if a link appears in multiple queries by the same user, delta scores for the link can be can be calculated for each of the queries, and then all delta scores for the link are combined to produce a total delta score for the link. Delta scores could also be calculated using any other mathematical technique that produces a result that reflects a change in an item's rank from one search result to the next, such as, for example, calculating a difference between the logarithm or square root of a result's respective rank in a search result.

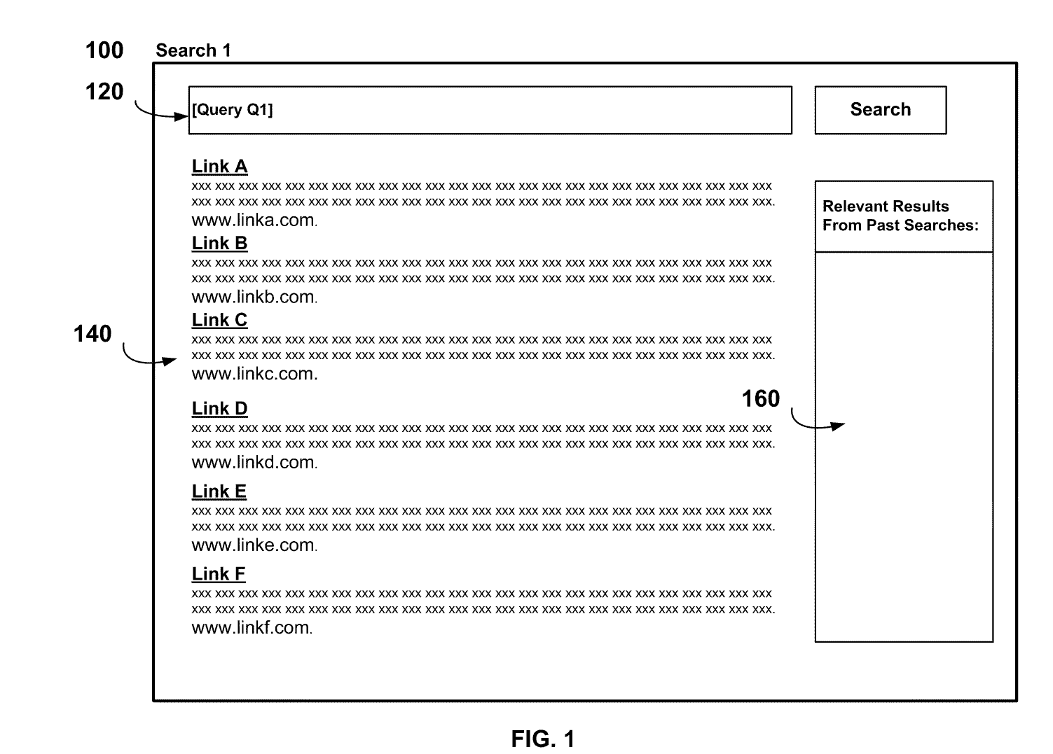

FIG. 1-4 illustrate one example of a method and user interface for displaying changes in search result relevance. FIG. 1-3 shows a web search page 100. The page has elements commonly associated with a web search page, including a search query entry text box 120. The page displays one or more links within a search page result 140. Each link is formatted to include a title, summary text and link information. The links are ranked in order of relevance as determined by search engine algorithms. The web search page 100 additionally displays an area 160 titled “Relevant Results From Past Searches”, whose use will be described below.

FIG. 1 displays the results of a query Q1 submitted by a user U1 on a first date D1. The result set contains links A, B, C, D, E and F ranked in that order. For the purposes of this example, the entire result set is displayed, however, it should be understood that the result set could span multiple display pages.

In one embodiment, information relating to the search results are stored in association with query Q1, an identification of the user issuing the query and the date and time D1 of the query. In one embodiment, the information relating to the search results comprises entries for each of the links A, B, C, D, E and F, each of entries comprising an identification of the link (e.g. a URL), and a link rank. In one embodiment, information relating to all links in the search result is stored. In one embodiment, information relating to a fixed set of the links in the result set is stored, for example, the top 100 ranked links.

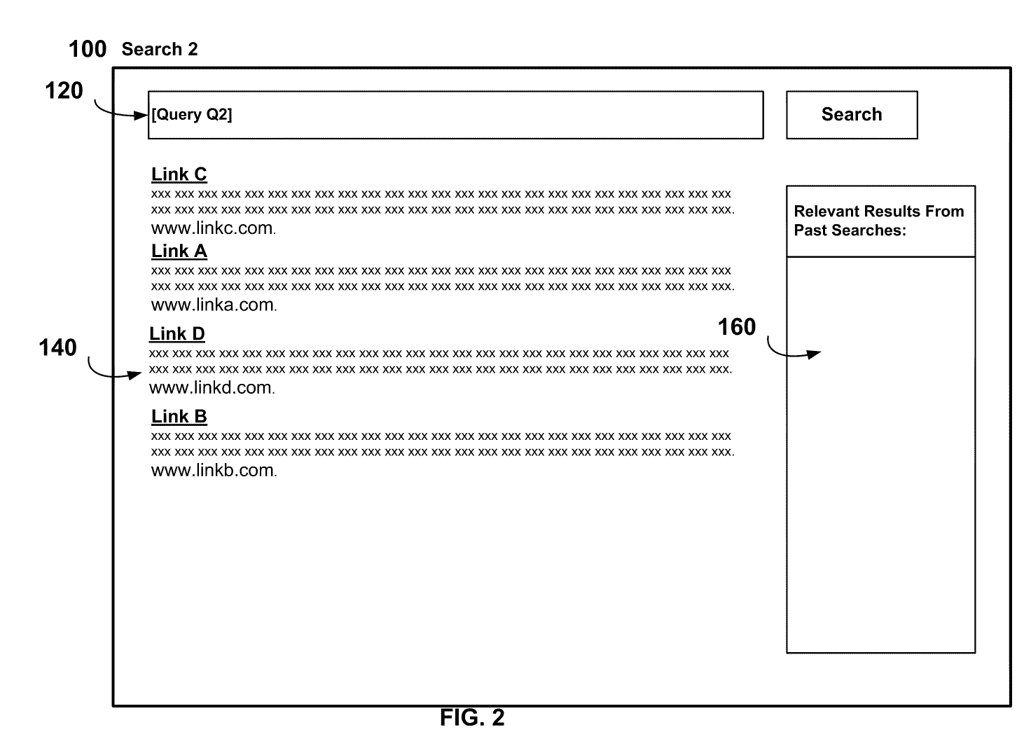

In FIG. 2, the user U1 has issued a second query, Q2, on a second date D2. A result set for the query containing links C, A, D and B is displayed. Information relating to the search results for the second query are stored in association with query Q2, an identification of the user U1 issuing the query and the date and time D2 of the query.

In addition to processing query Q2, in one embodiment, the query Q1 is reprocessed and a new result set for the query Q1 is generated. The search results for Q1 for D1 are compared to the search results for Q1 for D2. Where the rank of a link is changed, a delta score is computed for such link. For example, assume that Q1 on D2 produces a result set where the results are ranked in the order link E, B, A, C, D and F. Comparing this to the original ranking of A, B, C, D and E, and F delta scores could be computed as follows: A=(1−3)=−2; B=(2−2)=0; C=(3−4)=−1; D=4−5=−1; E=(5−1)=+4; and F=(6−6)=0. These delta scores can then be stored in association with query Q1, an identification of the user issuing the query and the date and time D2 that the delta scores were computed.

In the illustrated embodiment, the delta scores for Q1 are computed after the query Q2 has been processed and displayed, and thus, are not themselves displayed. Note, however, the computation of delta scores for Q1 could have been performed immediately before Q2 was processed or at some time prior to the user's entry of query Q2.

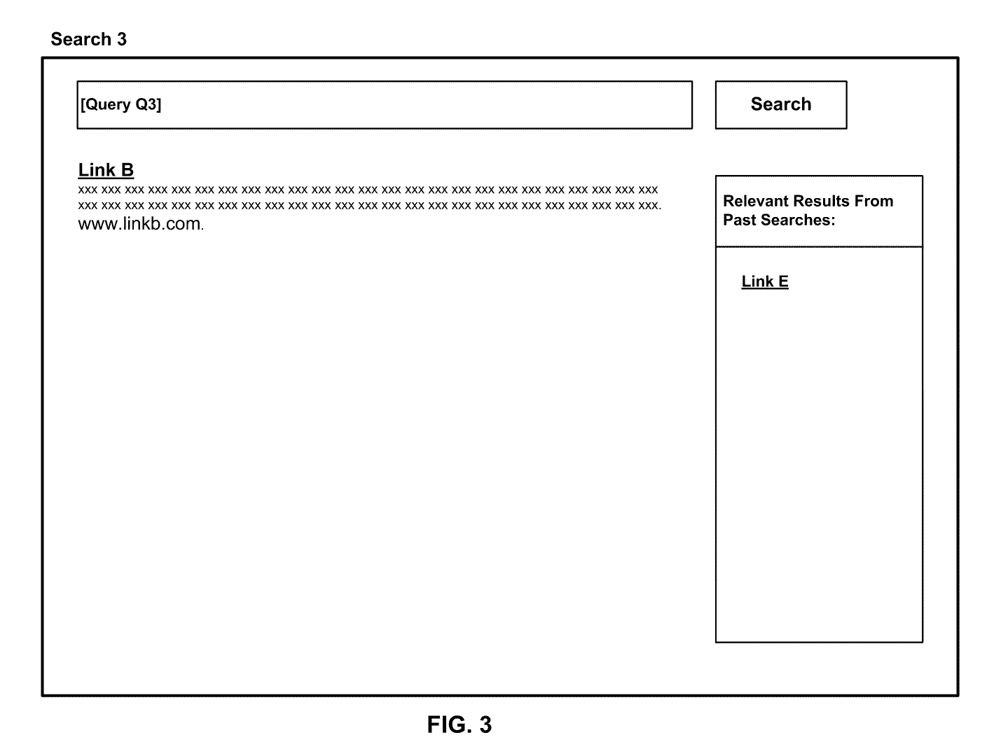

In FIG. 3, the user U1 has issued a third query, Q3, on a third date D2. A result set for the query containing link d B is displayed. Information relating to the search results for the third query are stored in association with query Q3, an identification of the user U1 issuing the query and the date and time D3 of the query.

Additionally, the delta scores for query Q1 are checked to see if any links changed positively in rank. In the illustrated embodiment, link E is the only link that has changed positively in rank (+4) and is thus displayed in the “Relevant Results From Past Searches” component 160 of the search results webpage 100. In the illustrated embodiment, the link is displayed as a hyperlink with no other descriptive material.

After query Q3 has been processed, delta scores can be determined for queries Q1 and Q2, since there are prior search results stored for both. In the case of Q1, delta scores could be computed with reference to the original search performed on D1 or could be computed with reference to the last search performed on D2. In one embodiment, where a specific link appears in the search results of more than one query for a specific user, the delta scores could be combined for that link for that specific user.

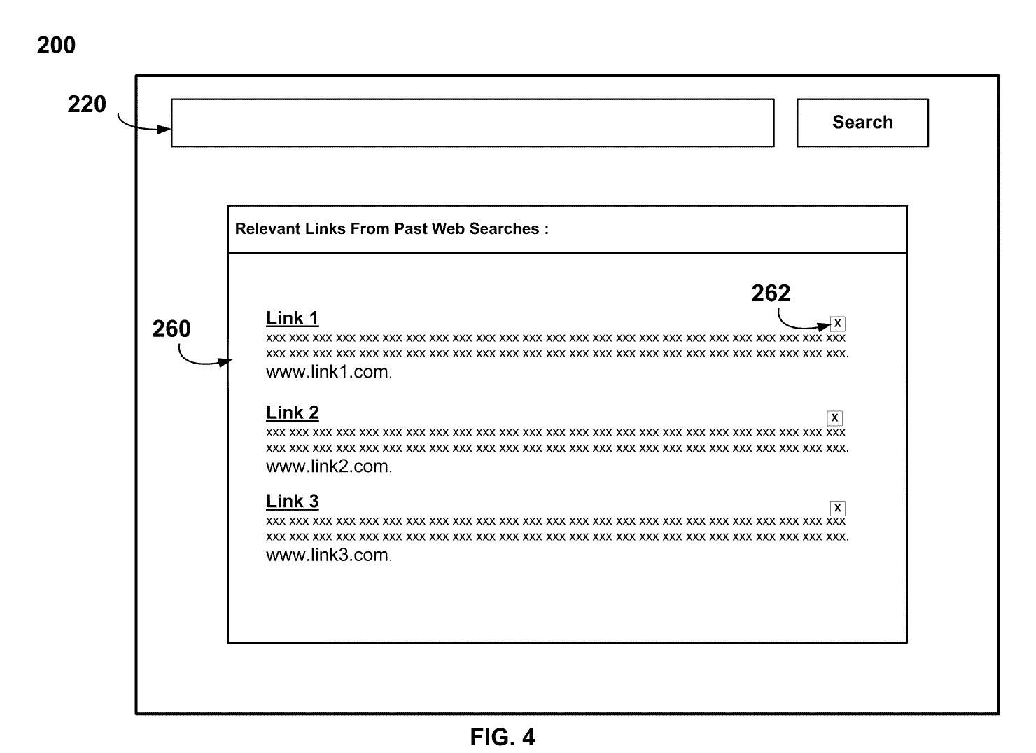

FIG. 4 illustrates an alternative method for displaying links with the highest delta score for a specific user. FIG. 4 shows a web search page 200, including a search query entry text box 220. The web search page 200 additionally displays an area 260 titled “Relevant Links From Past Web Searches” 260. In one embodiment, the area 260 is displayed when a user first displays the webpage 200. The area 260 displays links having the highest, positive delta scores for that user are displayed ranked by delta score. The delta scores for the links 1, 2 and 3 may have been computed based on one or more queries previously executed by the user.

The area 260 can be configured to display a fixed number of links (e.g. 3, as in the example), or may resize or scroll to accommodate any number of links. Each link entry can display a title/hyperlink, and additional descriptive information such as link name and summary text. Each link entry may additionally provide a link deletion box 262 that, when clicked, removes the link from the display area 260, and can additionally stop the computation of delta scores for that link going forward.

Other, alternative methods could additionally be used to display relevant links, for example, a drop-down menu immediately below the entry text box 220 or a pop-up dialog that can be initiated through a right mouse click.

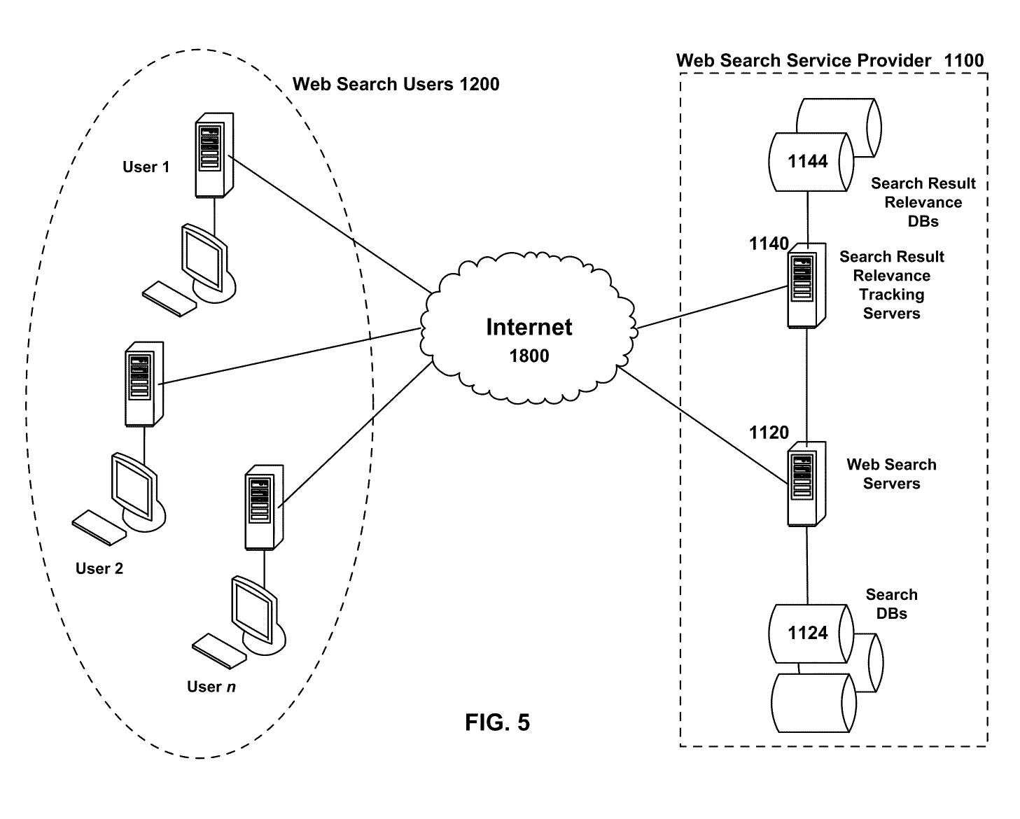

FIG. 5 illustrates one embodiment of a system 1000 capable of supporting at least one embodiment of the systems and methods described herein.

A service provider 1100 provides web search services including methods for detecting changes in search result relevance. Web search services are supported by a cluster of web search servers 1120. The web search services can include conventional web search services such as that currently provided by, for example, Yahoo! and Google, and can also include enhanced services. The servers 1120 are operatively connected to storage devices 1124 which can support various databases for supporting web search services such as, for example, directories or indexes.

Services for detecting changes in search result relevance, such as those described above, are supported by a cluster of servers 1140. The servers 1140 are operatively connected to storage devices 1144 which can support various databases for supporting services for detecting changes in search result relevance such as, for example, one or more databases for storing information relating to search results, including delta scores for individual links within such search results. In the illustrated embodiment, the servers providing services for detecting changes in search result relevance 1140 are shown as a separate cluster of servers from those providing web search services 1120, however it should be understood that a single server or cluster of server could support web search service and query rewriting services such as those discussed herein.

The servers providing web search services 1120 and services for detecting changes in search result relevance 1140 are operatively connected to each other and are further connected to an external network such as, for example, the Internet 1800. Via the Internet 1800, one or more users 1400 are operatively connected to the servers 1120 and 1140, and can access services available on such servers. Users 1200 can, inter alia, enter web queries using their respective computing devices.

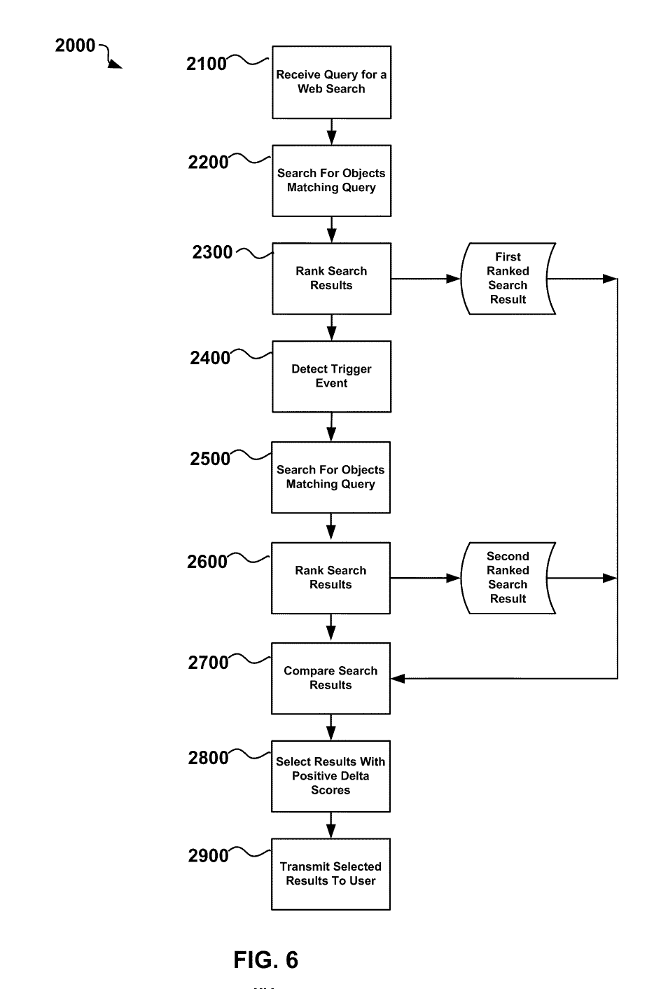

FIG. 6 illustrates one embodiment of a process 2000 for providing search services which include detection of changes in search result relevance.

The process begins when a web search query is received 2100 from a user, via a network, for example, a server providing search services. In one embodiment, the query comprises a plurality of query tokens. In a typical web query, the tokens will be words, but they may also could also any other symbol which has meaning to the user entering the query. The user may have entered the query from any device having access to the network such as, for example, desktop computers, laptop computers, PDAs, cell phones and so forth.

The query is then processed by at least one computing device to search 2200 for a first plurality of objects accessible over the network which match the query, producing a first search result. In one embodiment, the first search result comprises a plurality of references, each reference referring to one of the first plurality of objects. The query may be processed using any technique known in the art, such as, for example, as a bag of words and can alternatively or additionally use any advanced search techniques known in the art. References in the search result can comprise hyperlinks to network accessible objects, such as documents or media objects. Search results can additionally include information such as summary text.

The first search result is then ranked 2300 using the computing device using a using a ranking methodology producing a first ranked search result. The ranking methodology can be any ranking methodology known in the art, including simple methodologies such as term frequency, or more advanced methodologies, such as entity detection and ranking, or any other methodology now known or later developed.

The occurrence of a trigger event is then detected 2400 using the computing device. A triggering event could be any kind of condition or event that indicates one or more past searches should be reevaluated for changes in search result relevance. For example, in one embodiment, a user may have a user ID and profile known to a service provider that provides, inter alia, search services, such as Google or Yahoo! Every time the user logs into the service, all or a subset of all the queries the user has issued in the past are reevaluated for changes in search relevance. In one embodiment, the trigger event could be the passage of a predetermined time interval.

In one embodiment, the query is processed by the computing device to search 2500 for a second plurality of objects accessible over the network which match the query, whereby a second search result is produced, the second search result comprising a plurality of references, each reference referring to one of the second plurality of objects. The query may be processed using any technique known in the art, such as, for example, as a bag of words and can alternatively or additionally use any advanced search techniques known in the art. References in the search result can comprise hyperlinks to network accessible objects, such as documents or media objects. Search results can additionally include information such as summary text.

The second search result is then ranked 2600 using the computing device using a using a ranking methodology producing a second ranked search result. The ranking methodology can be any ranking methodology known in the art, including simple methodologies such as term frequency, or more advanced methodologies, such as entity detection and ranking, or any other methodology now known or later developed. In one embodiment, the methodology used to rank the first search result is the same methodology used to rank the second search result. In one embodiment, the methodology used to rank the first search result is a different methodology used to rank the second search result.

In one embodiment, search results are stored on a computer readable medium in association with the query that produced the search result and the user submitting the query. For example, in one embodiment, a user may have a user ID and profile known to a service provider that provides, inter alia, search services, and queries and search results are stored in association with the user ID. In one embodiment, the size of search results is limited, for example, to a predetermined number, such as 300 references. In one embodiment, queries and associated search results are retained indefinitely. In one embodiment, queries and associated search results are retained for a limited time, for example, one month.

The first ranked search result is then compared 2700 with the with the second ranked search result using the computing device, wherein a delta score is determined for each reference in the second ranked search result. In one embodiment, if there the reference matches a reference in the first ranked search result, the delta score is computed by subtracting the rank of the reference in the second ranked result set from the rank of the reference in the first ranked result set. In one embodiment, if a reference is not in the first ranked search result, the delta score is computed by subtracting the rank of the reference in the second ranked result set from a default rank, such as the number of references in the first or second ranked result or a fixed number, such as 300.

In one embodiment, the first search result represents the search result produced the first time the query was processed for the user. In one embodiment, the first search result represents the search result produced the last time the query was processed for the user prior to the production of the second search result.

In one embodiment, the delta scores are stored on a computer readable medium in association with the query that produced the search result and the user submitting the query. For example, in one embodiment, a user may have a user ID and profile known to a service provider that provides, inter alia, search services, and the delta scores are stored in association with the user ID.

At least one of the references in the second ranked result set having a positive delta score is selected 2800 using the computing device. In one embodiment, all references having a positive delta score are selected. In one embodiment, a fixed number references, for example, five, having the most positive delta scores are selected. In one embodiment, only references which were not previously selected are selected. In one embodiment, references previously selected a predetermined number of times, for example, five, are not selected.

The selected references in the second ranked result set to the user are then transmitted 2900 over the network to the user. In one embodiment, the references are transmitted with their respective delta score. In one embodiment, the selected references are displayed on a user interface such as those shown in FIG. 1-4.

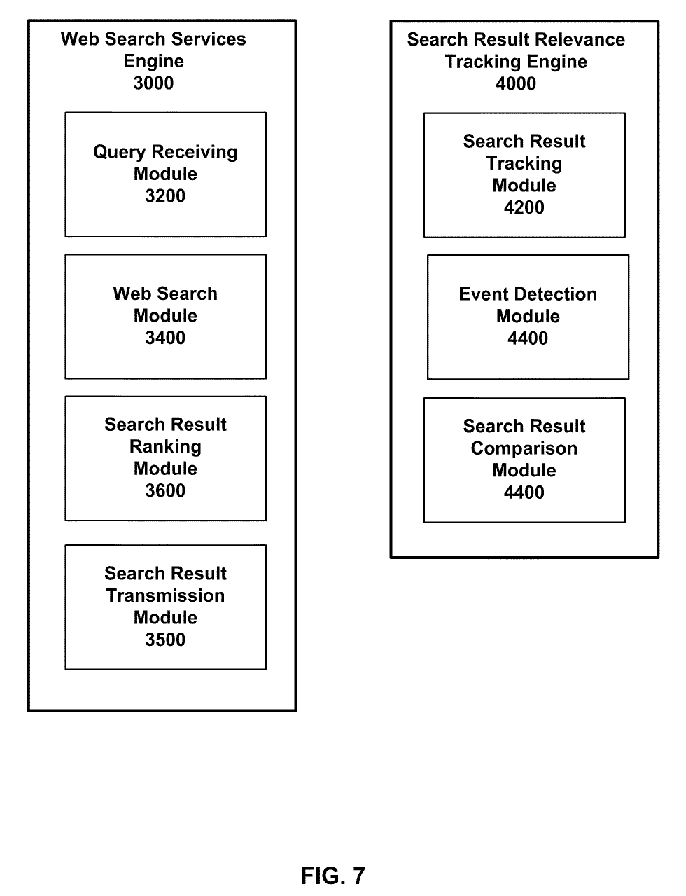

FIG. 7 illustrates one embodiment of a web search services engine 3000 and a search result relevance tracking engine 4000, that, in conjunction, are capable of supporting at least one embodiment of the process described in FIG. 6 above. In one embodiment, the web search services engine 3000 comprises a query receiving module 3200, a web search module 3400, a search result ranking module 3600, and a search result transmission module 3800. In one embodiment, the search result relevance tracking engine 4000 comprises a search result tracking module 4200, an event detection module 4400 and a search result comparison module 4600. In one embodiment, web search services engine 3000 is hosted on one or more servers hosted by a service provider 100, such as the web search services servers 1120 shown in FIG. 5. In one embodiment, search result relevance tracking engine 4000 is hosted on one or more servers hosted by a service provider 100, such as the search result relevance tracking servers 1140 shown in FIG. 5.

In one embodiment, each of the managers comprises one or more processors programmed to execute software code retrieved from a computer readable storage medium storing software for functions as described below. In one embodiment, each of the modules could be hosted on one or more servers hosted by a service provider, such as the service 100 shown in FIG. 1. Such an embodiment is purely exemplary, and all of the managers shown could be implemented in any combination on any number servers, as will be readily apparent to those skilled in the art.

In one embodiment, the query receiving module 3200 is configured to receive web search queries is received from a users, via a network. In one embodiment, the query comprises a plurality of query tokens. In a typical web query, the tokens will be words, but they may also could also any other symbol which has meaning to the user entering the query. The user may have entered the query from any device having access to the network such as, for example, desktop computers, laptop computers, PDAs, cell phones and so forth.

In one embodiment, the web search module 3400 is configured to process queries received by the query receiving module 3200 so as to search for objects accessible over the network which match each query, whereby a search result is produced for each query. In one embodiment, each search result comprises a plurality of references, each reference referring to one of a plurality of objects matching the respective query. The query may be processed by the web search module 3400 using any technique known in the art, such as, for example, as a bag of words and can alternatively or additionally use any advanced search techniques known in the art. References in search result can comprise hyperlinks to network accessible objects, such as documents or media objects. Search results can additionally include information such as summary text.

In one embodiment, the search result ranking module 3600 is configured to rank search results using a ranking methodology, whereby ranked searched results are produced. The ranking methodology used by the search result ranking module 3600 can be any ranking methodology known in the art, including simple methodologies such as term frequency, or more advanced methodologies, such as entity detection and ranking, or any other methodology now known or later developed.

In one embodiment, the search result transmission module 3800 is configured to transmit ranked search results, over the network, to users submitting queries. In one embodiment, the search result transmission module 3800 is configured to transmit references selected by the search result comparison module 4600 (as described below) over the network, to users. In one embodiment, the references are transmitted with their respective delta score. In one embodiment, the selected references are displayed on a user interface such as those shown in FIG. 1-4.

In one embodiment, the search result tracking module 4200 stores search results on a computer readable medium in association with the queries that produced the search result and the user submitting the query. For example, in one embodiment, a user may have a user ID and profile known to a service provider that provides, inter alia, search services, and queries and search results are stored in association with the user ID. In one embodiment, the size of search results is limited, for example, to a predetermined number, such as 300 references. In one embodiment, queries and associated search results are retained indefinitely. In one embodiment, queries and associated search results are retained for a limited time, for example, one month.

In one embodiment, the event detection module 4400 detects the occurrence of trigger events associated with queries and search results tracked by the search result tracking module 4200. A triggering event could be any kind of condition or event that indicates one or more past searches should be reevaluated for changes in search result relevance. For example, in one embodiment, a user may have a user ID and profile known to a service provider that provides, inter alia, search services, such as Google or Yahoo! Every time the user logs into the service, all or a subset of all the queries the user has issued in the past are reevaluated for changes in search relevance. In one embodiment, the trigger event could be the passage of a predetermined time interval.

In one embodiment, upon detection of a trigger event associated with one or more queries, the search result tracking module 4200 causes the queries associated with the events to be processed by the web search module 3400 and the search result ranking module 3600, creating new search results for each query. In one embodiment, the new search results are stored by the search result tracking module 4200 on a computer readable medium in association with the queries that produced the search result and the user submitting the query.

In one embodiment, the search result comparison module 4600 compares ranked search results with one another when new search results are created by the web search module 3400 and the search result ranking module 3600 in response to trigger events detected by the event detection module 4400. In one embodiment, for each trigger event, the new search result set is compared to an earlier search result associated with the same query and user. In one embodiment, a delta score is determined for each reference in the new ranked search result, wherein if there the reference matches a reference in the earlier ranked search result, the delta score is computed by subtracting the rank of the reference in the new ranked result set from the rank of the reference in the earlier ranked result set. In one embodiment, the earlier search result represents the search result produced the first time the query was processed. In one embodiment, the earlier search result represents the search result produced the last time the query was processed prior to the production of the new search result.

In one embodiment, the search result tracking module 4200 stores the delta scores on a computer readable medium in association with the search result from which the scores were determined, the query that produced the delta scores and the user submitting the query. For example, in one embodiment, a user may have a user ID and profile known to a service provider that provides, inter alia, search services, and the delta scores are stored in association with the user ID.

In one embodiment, the search result comparison module 4600 is further configured to select references in ranked result sets having a positive delta scores. In one embodiment, all references having a positive delta score. In one embodiment, a fixed number references per user are selected, for example, five, having the most positive delta scores. In one embodiment, only references which were not previously selected are selected. In one embodiment, references previously selected a predetermined number of times for a given user, for example, five, are not selected.

The selected references are then transmitted by the search result transmission module 3800, over the network to users associated with the search results from which the selected references were chosen. In one embodiment, the references are transmitted with their respective delta score. In one embodiment, the selected references are displayed on a user interface such as those shown in FIG. 1-4.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method comprising the steps of:
receiving a query for a web search from a user, via a network;
searching, using at least one computing device, for a first plurality of objects accessible over the network which match the query, whereby a first search result is produced, the first search result comprising a plurality of references, each reference referring to one of the first plurality of objects;
ranking, using at least one computing device, the first search result using a first ranking methodology, producing a first ranked search result;
detecting, using the computing device, the occurrence of a trigger event;
searching, using at least one computing device, for a second plurality of objects accessible over the network which match the query, whereby a second search result is produced, the second search result comprising a plurality of references, each reference referring to one of the second plurality of objects;
ranking, using at least one computing device, the second search result using a second ranking methodology, producing a second ranked search result;
comparing, using at least one computing device, the first ranked search result with the second ranked search result, wherein a delta score is determined for each reference in the second ranked search result;
selecting, using at least one computing device, at least one of the references in the second ranked result set having a positive delta score;
transmitting, over the network, the at least one of the references in the second ranked result set to the user.

2. The method of claim 1 wherein the delta score is computed such that if the reference in the second ranked result matches a reference in the first ranked search result, the delta score is computed by subtracting the rank of the reference in the second ranked result set from the rank of the reference in the first ranked result set.

3. The method of claim 2 wherein if the reference in the second ranked result is not in the first ranked search result, the delta score is computed by subtracting the rank of the reference in the second ranked result set from a default rank.

4. The method of claim 3 wherein the default rank is the number of references in the first or second ranked result.

5. The method of claim 3 wherein the default rank is a fixed number.

6. The method of claim 1 wherein the first ranking methodology and the second ranking methodology are the same ranking methodology.

7. The method of claim 1 wherein the first ranking methodology and the second ranking methodology are different ranking methodologies.

8. The method of claim 1 wherein the trigger event is the user logging into a service.

9. The method of claim 1 wherein the trigger event is the lapse of a time interval.

10. The method of claim 1 wherein the number of references in the first ranked search result and the number of references in the second ranked search result which are compared to one another is a fixed number.

11. The method of claim 1 wherein the first ranked search result represents the search result produced the first time the query was processed for the user.

12. The method of claim 1 wherein the first ranked search result represents the search result produced the last time the query was processed for the user prior to the production of the second search result.

13. The method of claim 1 wherein, in the selecting step, a fixed number references having the most positive delta scores are selected.

14. The method of claim 1 comprising the additional steps of:
receiving an indication from the user, via the network, that the user is not interested at least one of the selected references, wherein the at least one of the selected references is removed from the first ranked result set and the second ranked result set.

15. A system comprising:
a query receiving module comprising one or more processors programmed to execute software code retrieved from a computer readable storage medium storing software for receiving queries for web searches from users, via a network;
a web search module comprising one or more processors programmed to execute software code retrieved from a computer readable storage medium storing software for searching, using queries, for pluralities of objects accessible over the network which match the respective queries, each plurality of objects comprising a search result for a query processed by the web search module;
a search result ranking module comprising one or more processors programmed to execute software code retrieved from a computer readable storage medium storing software for ranking each of the search results using a ranking methodology, producing ranked search results;
an event detection module comprising one or more processors programmed to execute software code retrieved from a computer readable storage medium storing software for detecting the occurrence of a trigger events related to queries processed by the web search modules;
a search result comparison module comprising one or more processors programmed to execute software code retrieved from a computer readable storage medium storing software for comparing a first ranked search result produced by the search result ranking module with a second ranked search result produced by the search result ranking module, wherein a delta score is determined for each reference in the second ranked search results, wherein, for each such comparison, at least one of the references in the second ranked result set having a positive delta score is selected;
a search result transmission module comprising one or more processors programmed to execute software code retrieved from a computer readable storage medium storing software for transmitting, over the network, for each comparison, the at least one of the selected references in the second ranked result set to a user that originally entered the query.

16. The system of claim 15 wherein the delta score is computed such that if the reference in the second ranked result matches a reference in the first ranked search result, the delta score is computed by subtracting the rank of the reference in the second ranked result set from the rank of the reference in the second ranked result set.

17. The system of claim 16 wherein if the reference in the second ranked result is not in the first ranked search result, the delta score is computed by subtracting the rank of the reference in the second ranked result set from a default rank.

18. The system of claim 15 additionally comprising:
a search result tracking module comprising one or more processors programmed to execute software code retrieved from a computer readable storage medium storing software for storing search results on a computer readable medium in association with the queries that produced the search result and the user submitting the query.

19. The system of claim 18 wherein the size of search results stored by the search result tracking module is limited to a fixed number. In one embodiment, queries and associated search results are retained indefinitely. In one embodiment, queries and associated search results are retained for a limited time, for example, one month.

20. The system of claim 18 wherein search results are retained indefinitely. In one embodiment, queries and associated search results are retained for a limited time, for example, one month.

21. The system of claim 18 wherein search results are retained ted search results are retained for fixed time.

22. A computer-readable medium having computer-executable instructions for a method comprising the steps of:
receiving a query for a web search from a user, via a network;
searching, using at least one computing device, for a first plurality of objects accessible over the network which match the query, whereby a first search result is produced, the first search result comprising a plurality of references, each reference referring to one of the first plurality of objects;
ranking, using at least one computing device, the first search result using a first ranking methodology, producing a first ranked search result;
detecting, using the computing device, the occurrence of a trigger event;
searching, using at least one computing device, for a second plurality of objects accessible over the network which match the query, whereby a second search result is produced, the second search result comprising a plurality of references, each reference referring to one of the second plurality of objects;
ranking, using at least one computing device, the second search result using a second ranking methodology, producing a second ranked search result;
comparing, using at least one computing device, the first ranked search result with the second ranked search result, wherein a delta score is determined for each reference in the second ranked search result;
selecting, using at least one computing device, at least one of the references in the second ranked result set having a positive delta score;
transmitting, over the network, the at least one of the references in the second ranked result set to the user.

23. The computer-readable medium of claim 22 wherein the delta score is computed such that if the reference in the second ranked result matches a reference in the first ranked search result, the delta score is computed by subtracting the rank of the reference in the second ranked result set from the rank of the reference in the second ranked result set.

24. The computer-readable medium of claim 23 wherein if the reference in the second ranked result is not in the first ranked search result, the delta score is computed by subtracting the rank of the reference in the second ranked result set from a default rank.

25. The computer-readable medium of claim 22 wherein the first ranking methodology and the second ranking methodology are the same ranking methodology.

26. The computer-readable medium of claim 22 wherein the first ranking methodology and the second ranking methodology are different ranking methodologies.

27. The computer-readable medium of claim 1 comprising the additional steps of:
receiving an indication from the user, via the network, that the user is not interested at least one of the selected references, wherein the at least one of the selected references is removed from the first ranked result set and the second ranked result set.
